(19) United States
(12) Patent Application Publication
(10) Pub. No.: US 2006/0068872 A1
(43) Pub. Date: Mar. 30, 2006

(54) Method and apparatus for facilitating a wagering game with an indicia accumulation feature

(76) Inventors: Jay S. Walker, Ridgefield, CT (US); James A. Jorasch, New York, NY (US); Magdalena M. Fincham, Ridgefield, CT (US); Robert C. Tedesco, Fairfield, CT (US)

Correspondence Address: Magdalena M. Fincham;Walker Digital Management, LLC, Five High Ridge Park, Stamford, CT, 06905, US

(21) Appl. No.: 11/284,065

(22) Filed: Nov. 21, 2005

Related U.S. Application Data
(63) Continuation-in-part of application No. 09/716,918, filed on Nov. 20, 2000.
(60) Provisional application No. 60/637,248, filed on Dec. 17, 2004.
(60) Provisional application No. 60/637,249, filed on Dec. 17, 2004.
(60) Provisional application No. 60/637,376, filed on Dec. 17, 2004.

(51) Int. Cl. A63F 13/00

(52) U.S. Cl. 463/13

(57) ABSTRACT

An electronic amusement device and a method for operating the device are disclosed. In accordance with some embodiments, a slot machine or video poker machine identifies a tracked symbol and initializes a running count representing active occurrences of the tracked symbol generated during a play session. In one embodiment, in the context of a video poker game, the number of occurrences of a discarding of a qualifying card are counted. An occurrence of a tracked symbol (e.g., discarded qualifying card) may be associated with an expiration condition. In one embodiment, a bonus is provided if a predetermined number of occurrences of the tracked symbol are collected within a predefined period of time (e.g., if twelve aces are discarded and collected within six consecutive games).

### CLAIM OF PRIORITY

The present application is a continuation-in-part application of U.S. application Ser. No. 09/716,918, filed Nov. 20, 2000 in the name of Walker et al. and entitled ELECTRONIC AMUSEMENT DEVICE AND METHOD FOR ENHANCED SLOT MACHINE PLAY. The entirety of this application is incorporated by reference herein for all purposes.

The present application also claims the benefit of the following provisional applications, each of which is incorporated by reference herein for all purposes:
(i) U.S. Provisional Application Ser. No. 60/637,248, filed Dec. 17, 2004 and entitled ELECTRONIC AMUSEMENT DEVICE AND METHOD FOR ENHANCED SLOT MACHINE PLAY;
(ii) U.S. Provisional Application Ser. No. 60/637,249, filed Dec. 17, 2004 and entitled METHOD AND APPARATUS FOR FACILITATING ACCUMULATION OF GAME INDICIA; and
(iii) U.S. Provisional Application Ser. No. 60/637,376, filed Dec. 17, 2004 and entitled METHOD AND SYSTEM FOR VIDEO POKER.

### BACKGROUND

Modern casinos offer players a wide variety of game alternatives, including table games such as craps, blackjack and poker. Slot machines, however, constitute the major source of profits for casinos. Casinos therefore constantly strive to increase the attractiveness and playability of slot machines in ways that attract and retain players.

More particularly, it is of substantial value to a casino to encourage lengthier and faster play sessions at slot machines. When a player terminates play and walks away from a slot machine, that machine often goes unused for some period of time until a new player initiates play, thereby reducing revenue from that slot machine.

### BRIEF DESCRIPTION OF THE DRAWINGS

These and other objects, features and advantages of the invention will be understood from a consideration of the following description of the invention, in which:

FIG. 1 is a block diagram illustrating a system for implementing the present invention;

FIG. 2 is a block diagram of a slot server constructed in accordance with the present invention;

FIG. 3A is a block diagram of an electronic gaming device constructed in accordance with the present invention;

FIG. 3B is a plan view of the electronic gaming device of FIG. 3A;

FIG. 4A is a table showing components of the tracked symbol table of FIG. 3;

FIG. 4B is a table showing components of the occurrence table of FIG. 3;

FIG. 5 is a table showing components of the payout table of FIG. 3;

FIG. 6 is a table showing components of the probability table of FIG. 3;

FIG. 7 is a table showing components of the outcome table of FIG. 3;

FIG. 8 is a table showing components of the tracked symbol reward table of FIG. 3;

FIG. 9A-9B together comprise a flowchart illustrating a method for directing a slot machine to determine a bonus payout according to one embodiment of the present invention;

FIG. 10A is an example of information that may be displayed to a player of a gaming device, in accordance with an embodiment of the present invention; and

FIG. 10B is an example of updated information, updated from that of FIG. 10A, that may be output to a player of a gaming device, in accordance with an embodiment of the present invention.

### DETAILED DESCRIPTION OF SOME EMBODIMENTS

An object of some embodiments is to provide an improved method and apparatus for determining a bonus payout based on a running count of tracked symbol occurrences. An advantage of some embodiments for a casino operator is that it sustains the attention of slot machine players for a longer time, thereby increasing the average playing time for a slot machine. Another advantage of some embodiments for a casino operator is that it encourages faster slot machine play by players using the device. An advantage of some embodiments for a slot machine player is that it increases the excitement, anticipation and enjoyment of playing a slot machine.

In accordance with some embodiments, a method, apparatus and computer-readable medium are described for (i) determining, for a video poker game, a plurality of initial hands, each initial hand represented by a plurality of cards; (ii) counting occurrences of a discarding of at least one qualifying card from one or more of the plurality of initial hands, thereby determining a count value of the qualifying card; and (iii) determining a bonus payout based on a number of occurrences of the discarding of the at least one qualifying card counted in accordance with an expiration condition. The expiration condition may define, for example, at least one of (i) a number of game plays, from a game play in which an occurrence occurs, after which the occurrence expires and (ii) a period of time, from a time at which an occurrence occurs, after which the occurrence expires. In some embodiments, the expiration condition is associated with each respective occurrence, such that a first occurrence may expire at a first time and a second occurrence may expire at a second time that is different from the first time.

In accordance with some embodiments, an electronic amusement device and method is disclosed for directing a slot machine to process a bonus payout based on a running count of tracked symbol occurrences. The method includes the steps of identifying at least one tracked symbol and initializing a running count. The running count represents a number of occurrences of the tracked symbol, for example, during a particular time period or throughout a number plays of the slot machine.

The method also includes the step of generating an outcome represented by a set of symbols. The method further includes the step of determining an occurrence of any of the identified tracked symbols. The running count is adjusted accordingly, including increasing the running count to reflect occurrences of one of the tracked symbols and decreasing the running count to reflect expiration of occurrences of one of the tracked symbols. According to the method, a bonus payout is determined based on the running count.

Slot machines, including conventional reel slot machines, video poker, video keno and video blackjack machines, are generally among the most profitable casino games. Casino operators can capture the interest of slot players by offering a bonus payout in addition to a traditional payout. By determining the bonus payout based on aggregated results of multiple plays during a gaming session, casino operators can encourage slot players to increase the average duration of their sessions. Further, because the bonus payout is based on multiple plays, such a bonus increases the anticipation, entertainment and excitement of a slot player.

Some embodiments described herein are directed to an electronic gaming device and a method for operating an electronic gaming device to determine whether a number of occurrences of a tracked symbol during a session of slot play is sufficient to provide a bonus payout. In accordance with some embodiments, a running count of tracked symbols that have occurred is maintained during a gaming session, and a bonus payout is determined when the running count reaches or surpasses a predetermined amount. In some embodiments the tracked symbols do not expire.

According to some embodiments, a player begins a gaming session at a slot machine. During the session, the player plays a number of games, and generates an outcome for each game. Each outcome is represented by a set of symbols.

The slot machine identifies at least one tracked symbol, and throughout the session, the slot machine maintains a running count of the number of times the tracked symbol occurs in a generated outcome. In one embodiment, the running count may represent the number of times a specific symbol occurs in generated outcomes. In another embodiment, the running count may represent the number of times any tracked symbol occurs in generated outcomes.

Although each occurrence of a tracked symbol causes the running count to be increased, in some embodiments an expiration condition is associated with each occurrence of a tracked symbol defining the condition under which the occurrence expires. In accordance with some embodiments, an expiration condition is defined as a function of time or as a function of a number of plays. Upon the satisfaction of an expiration condition, the running count is decreased to reflect the expiration of an occurrence.

One embodiment will be further described with reference to a client-server architecture in which much of the processing is performed by the networked gaming device. Of course, one skilled in the art will recognize various alternate embodiments that are consistent with the spirit and scope of the present invention, including without limitation performing the processing steps at the slot server.

Apparatus Architecture

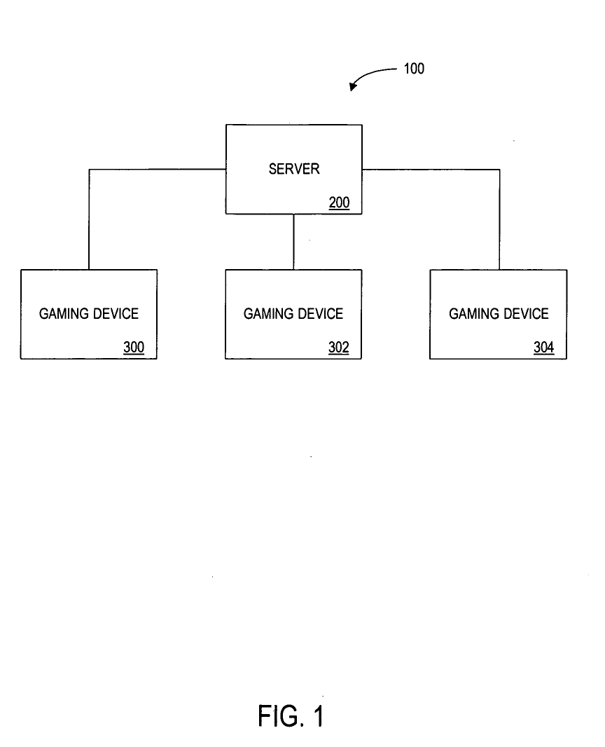

The apparatus architecture of an exemplary embodiment of the present invention will now be discussed with reference to FIGS. 1-3. Referring to FIG. 1, there is shown a block diagram of a slot network 100. Network 100 includes a slot machine server 200 (hereinafter referred to as “server”) that is linked to and communicates with networked gaming devices or slot machines 300, 302 and 304. Although three gaming devices are shown, a person of ordinary skill in the art will appreciate that any number of networked gaming devices could be linked to and in communication with server 200.

The network 100 may comprise, for example, a network designed to facilitate (e.g., via a specified protocol) communication with, monitoring and/or tracking of activity of the one or more slot machines. Such systems and protocols are well known in the art and need not be described in detail herein.

For example, a two-wire system such as one offered by International Gaming Systems (IGT) may be used. Similarly, a protocol such as the IGT SAS™ protocol or the SuperSAS™ protocol may be used. The SAS™ protocol and the SuperSAS™ protocol, respectively, allows for communication between gaming machines and slot accounting systems and provides a secure method of communicating all necessary data supplied by the gaming device to the on-line monitoring system. One aspect of the SAS™ protocol and the SuperSAS™ protocol that may be beneficial in implementing aspects of the present invention is the authentication function which allows operators and regulators to remotely interrogate gaming devices for important memory verification information, for both game programs, and peripheral devices.

In another example, a one-wire system such as the OASIS™ System offered by Aristocrat Technologies™ or the SDS slot-floor monitoring system offered by Bally Gaming and Systems™ may be used.

Each of the systems described above is an integrated information system that continually monitors slot machines and customer gaming activity. Thus, for example, any one of these systems may be used to monitor a player's gaming activity in order to determine player outcomes and other data relevant to tracking accumulation of game indicia by a player.

It should be noted that, in one embodiment, accumulation of game indicia (also referred to as symbols herein) is tracked for a single gaming session (e.g., from a time a player inserts a player tracking card into a slot machine or begins playing a slot machine to a time a player removes the player tracking card from the slot machine or ends playing the slot machine). As described herein, however, in another embodiment the accumulation of game indicia is tracked over a plurality of sessions, which may or may not be consecutive. Thus, as described, game indicia accumulated by a player may be stored on a server operable to communicate with a plurality of slot machines, on a player tracking card (e.g., in the form of a smart card) and/or elsewhere. In a further embodiment, a barcode of a cashless gaming receipt (e.g., a “ticket-in/ticket-out” scrip as known in the art) may encode data indicating game indicia accumulated by a player.

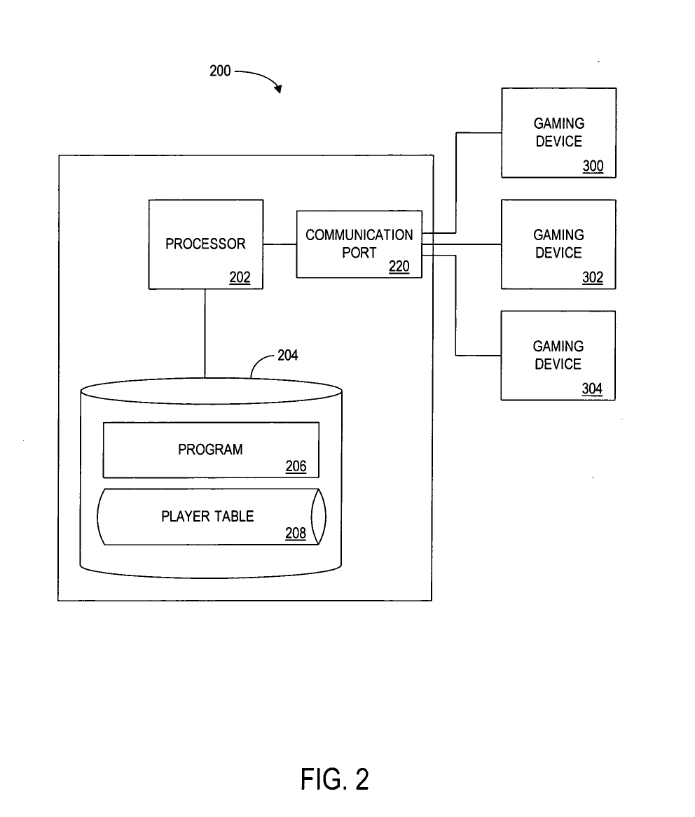

Referring now to FIG. 2, the architecture of slot machine server 200 is illustrated. In addition to conventional server components, server 200 includes a processor 202, a storage device 204 and a communication port 220. Communication port 220 enables server 200 to communicate with gaming devices 300, 302 and 304. Storage device 204 comprises an appropriate combination of magnetic and optical memory, such as disk drive memory, and semiconductor memory such as random access memory and read only memory. Storage device 204 contains program 206 and player table 208 for controlling server 200 in accordance with the present invention.

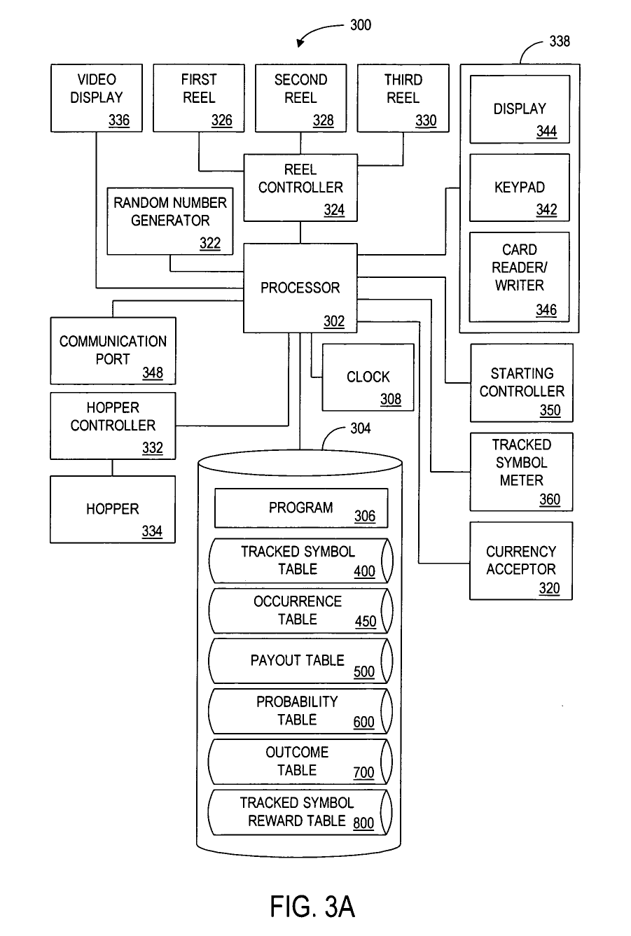

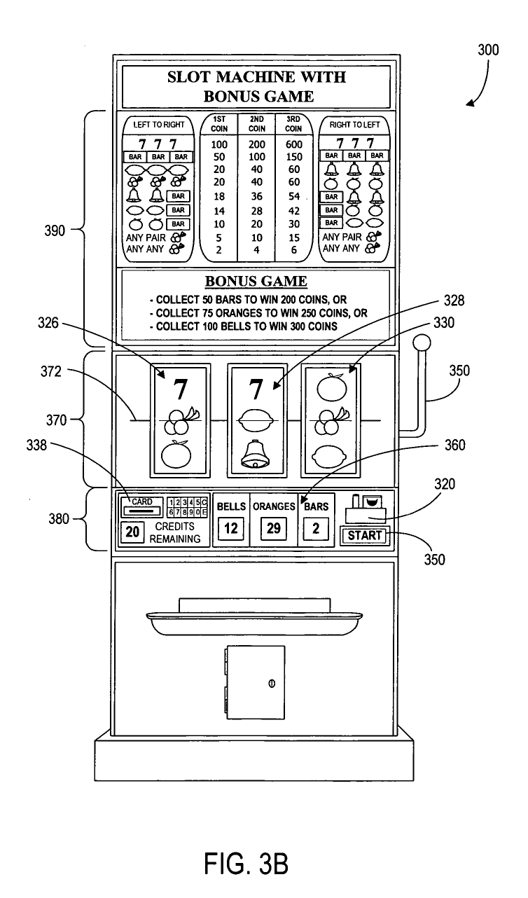

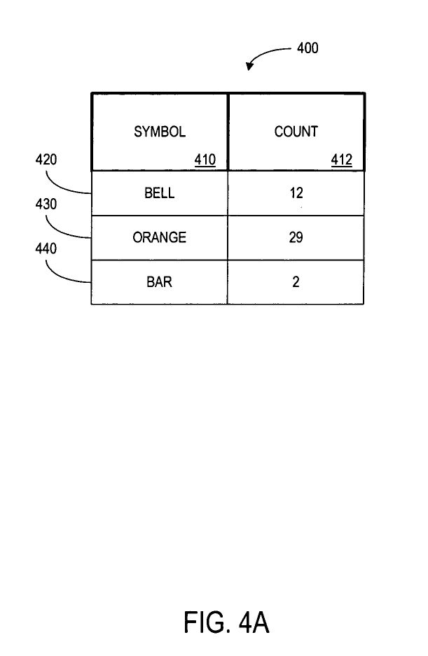

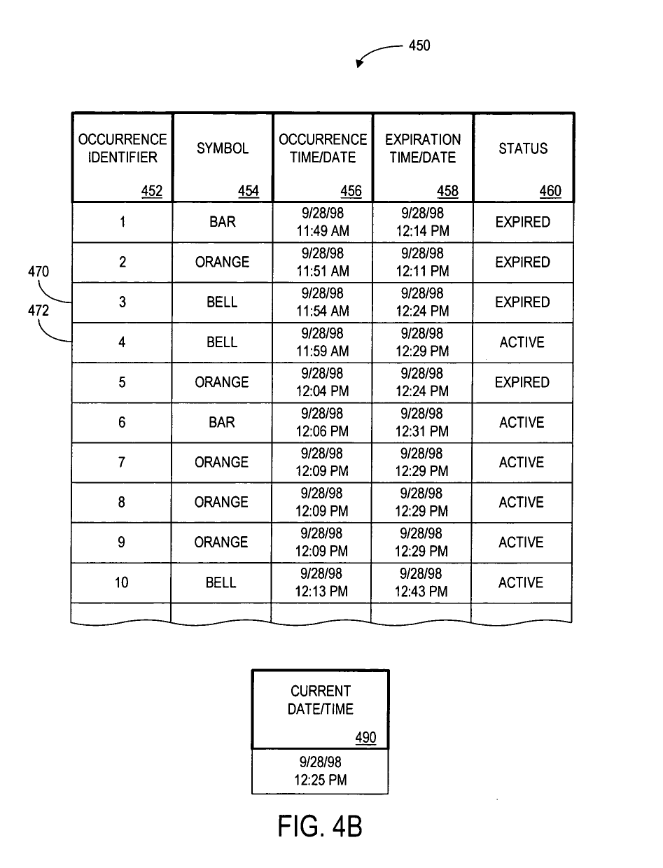

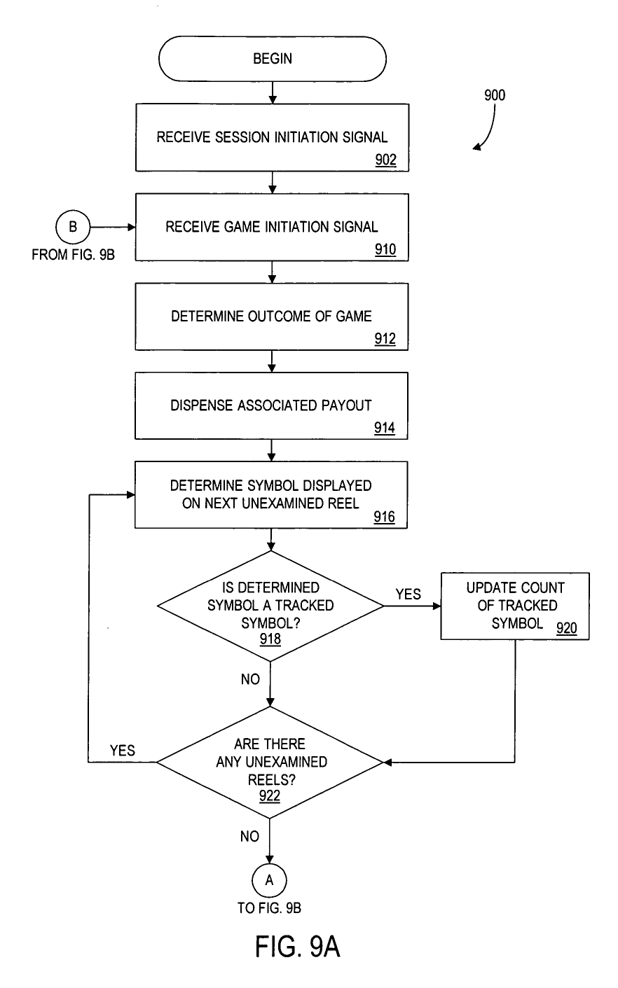

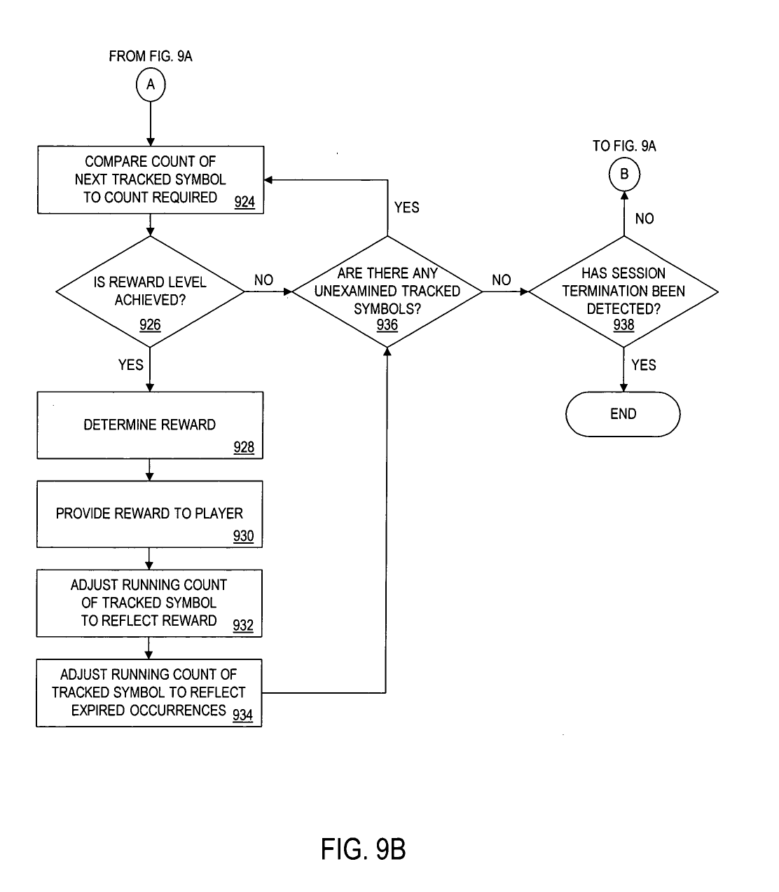

Referring now to FIG. 3A, the architecture of slot machine 300 is illustrated. Slot machine 300, which is substantially similar to slot machines 302 and 304, is controlled by processor 302 and communicates with slot server 200 via communication port 348. Processor 302 is connected to storage device 304 which stores program instructions and data for operating slot machine 300 in accordance with the present invention. Specifically, storage device 304 stores tracked symbol table 400, occurrence table 450, payout table 500, probability table 600, outcome table 700 and tracked symbol reward table 800, described more fully with reference to FIGS. 4A-8, respectively. Storage device 304 further stores program 306 which preferably includes instructions for conducting a game of chance and instructions for implementing the method of determining the bonus payout, as described more completely with reference to FIG. 9.

Further connected to processor 302 are a clock 308, a player card tracking device 338, a random number generator 322, a reel controller 324 for controlling reels 326, 328 and 330, a hopper controller 332 having an associated hopper 334, a currency acceptor 320, a video display 336 and a tracked symbol meter 360. It should be noted that video display 336 may display information which may serve as an adequate substitute for tracked symbol meter 360 as well as for reels 326, 328 and 330.

As illustrated, slot machine 300 comprises many conventional components. The non-conventional components of slot machine 300 include the program instructions and data stored in storage device 304 and the tracked symbol meter 360. For purposes of better illustrating the invention, conventional components, well known to those skilled in the art, are described only briefly. Although the present embodiment of the invention is described as implemented with physical components, the invention applies equally well to and includes software embodiments such as would be implemented on the Internet and other computer data networks.

Processor 302 may be embodied as one or more well known processing units, for example a Pentium class CPU manufactured by Intel Corp., or the like. Data storage device 304 comprises an appropriate combination of magnetic and optical memory, such as disk drive memory, and semiconductor memory such as random access memory and read only memory. In addition to the program instructions and data shown in FIG. 3, storage device 304 stores appropriate operating system and control software (not shown), functional to operate gaming device 300 in the manner described below. Random number generator 322 comprises one of many well known random or pseudo-random number generators suitable for use in a gaming device. Of course, as would be understood by one of ordinary skill in the art, a random number generator may be stored in another device that communicates random numbers to the slot machine 300.

Currency acceptor 320 is operative to receive one or more coins or bills, and to transmit an appropriate value signal to processor 302. Hopper controller 332, and hopper 334 connected thereto, are operative under the control of processor 302 to dispense coins to a player. Starting controller 350 comprises a player-operated device such as a handle or button for initiating the play of a game.

Player card tracking device 338 comprises a player tracking interface including a card reader/writer 346 for receiving a player tracking card (not shown), a display 344 for communicating messages to the player, and a keypad 342 for receiving player input such as a player identifier.

Slot machine 300 may of course include additional or different components from those illustrated in FIG. 3A. For example, in embodiments in which a smart card is utilized to implement one or more embodiments of the present invention, slot machine 300 may include a smart card reader device. In another example, in embodiments in which a cashless gaming receipt is utilized to implement one or more embodiments of the present invention, slot machine 300 may include a cashless gaming receipt reader and/or writer device. For example, the processor 302 may also be in communication with a ticket reader (not shown), which is capable of reading, for example, receipts, coupons, cashless gaming receipts and/or tickets, and particularly indicia registered on any such substrates. The ticket reader may use optical sensing of printed indicia, for example, and optical character recognition to read indicia from a ticket inserted in the ticket reader. In some embodiments, a device used to output and receive such cashless gaming receipts may also be used to receive currency (e.g., bills), as is known in the art (e.g., a currency acceptor may be capable of accepting more than one type of currency).

Referring now to FIG. 3B, a front plan view is shown of slot machine 300 of the present invention which, for purposes of discussion, is generally divided into three sections: a central panel 370, a lower panel 380, and an upper panel 390. Central panel 370 includes the display of first reel 326, second reel 328, and third reel 330. Each of these reels is configured to display the symbols printed on an associated reel strip. The reels may be mechanical in nature, or electronically represented with outputs shown on conventional electronic displays, such as a liquid crystal display (“LCD”). Central panel 370 includes a payline 372 that indicates the symbols of a resultant outcome. Central panel 370 further includes starting controller 350, in the form of a handle.

Lower panel 380 houses player tracking device 338. To the right of player tracking device 338 is tracked symbol meter 360 which indicates the number of tracked symbols which have been accumulated by the player. On the right portion of lower panel 380 is currency acceptor 320 and starting controller 350. A player tracking device may also comprise a small display screen (not shown) for outputting various data, such as data regarding accumulated symbols, rewards points, and so on. Various commercially available devices may be suitable for such an application, such as the NextGen™ interactive player tracking panel manufactured by IGT or the iVIEW display screen manufactured by Bally® Gaming and Systems. Such devices may also function to receive player input (e.g., such that a player may access data associated with tracked symbols on demand).

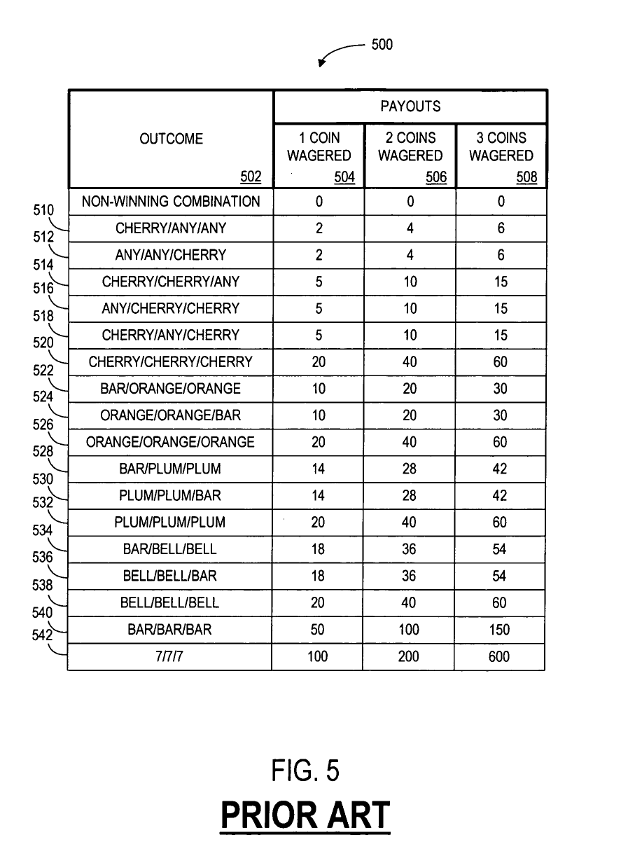

Upper panel 390 includes a display showing the contents of payout table 500 which describes all possible payouts for the slot machine, the details of which are discussed with respect to FIG. 5. The information is typically printed in bright colors and may be back-lit for easier viewing. Upper panel 390 also includes a display showing the requirements and payouts of the bonus game.

Data Tables

Referring now to FIG. 4A, there are illustrated three representative records of an exemplary tracked symbol table 400. As illustrated, each record of tracked symbol table 400 represents the progress of a player toward achieving a bonus associated with a tracked symbol. Each record of tracked symbol table 400 includes a symbol 410 and a count 412. Symbol field 410 identifies the tracked symbol associated with the record, and running count field 412 identifies the number of non-expired occurrences of the symbol generated during a session. Accordingly records 420, 430 and 440 of tracked symbol table 400 show that during the current session of play, a player has an active total of 12 bell symbols, 29 orange symbols and 2 bar symbols, respectively. The displayed running count for each tracked symbol is periodically adjusted to account for expired occurrences of tracked symbols.

Referring now to FIG. 4B, there are illustrated ten representative records of an exemplary occurrence table 450. Each record of occurrence table 450 represents a single occurrence of a tracked symbol generated during a session. Each record of occurrence table 450 includes occurrence identifier field 452 which uniquely identifies a record. Symbol field 454 identifies the tracked symbol associated with the record.

The time and date that the symbol was generated is stored in occurrence time/date field 456, and time at which the occurrence expires is stored in expiration time/date field 458. Although the expiration time/date is illustrated as an expiration condition, other expiration conditions are also possible, such as number of plays. As illustrated by the records of occurrence table 450, ORANGE symbols expire twenty minutes after occurring, BAR symbols expire twenty-five minutes after occurring and BELL symbols expire thirty minutes after occurring. Although the exemplary records reflect expiration periods that are based on the associated tracked symbol, in an alternate embodiment of the present invention, random expiration periods could be assigned for every occurrence.

Status field 460 represents the status of the occurrence represented by a record. Status field 460 can store an indication of “ACTIVE” or “EXPIRED.” If status field 460 contains “ACTIVE,” the occurrence is included in the running count for the associated symbol. If status field 460 contains “EXPIRED,” the occurrence of the symbol is not included in the running count. Assuming that clock 308 generates the current date/time of Sep. 28, 1998 12:25 pm, as illustrated by reference numeral 490, records 470 and 472 illustrate the use of status field 460. As shown, the occurrence represented by record 470 expired at 12:24 pm, one minute prior to the current date/time. Accordingly, status field 460 of record 470 is set to “EXPIRED.” Similarly, the occurrence represented by record 472 will expire at 12:29 pm, four minutes from the current date/time. Thus, status field 460 of record 472 is set to “ACTIVE.”

Referring now to FIG. 5, there is depicted an exemplary conventional payout table 500. Each record of payout table 500 defines the payout awarded for each outcome, or family of outcomes, based on the number of coins wagered. Payout table 500 includes outcome field 502 representing the outcome or family of outcomes associated with a record. Payout table 500 also includes payout fields 504, 506 and 508 representing the payouts for wagers of one, two and three coins, respectively. For example, if a player wagers one coin on a play that results in an outcome of “BAR/ORANGE/ORANGE,” slot machine 300 would provide a payout of ten coins, according to payout field 504 of record 522. If two coins were wagered on a play having the same outcome, slot machine 300 would provide a payout of twenty coins, according to payout field 506 of record 522.

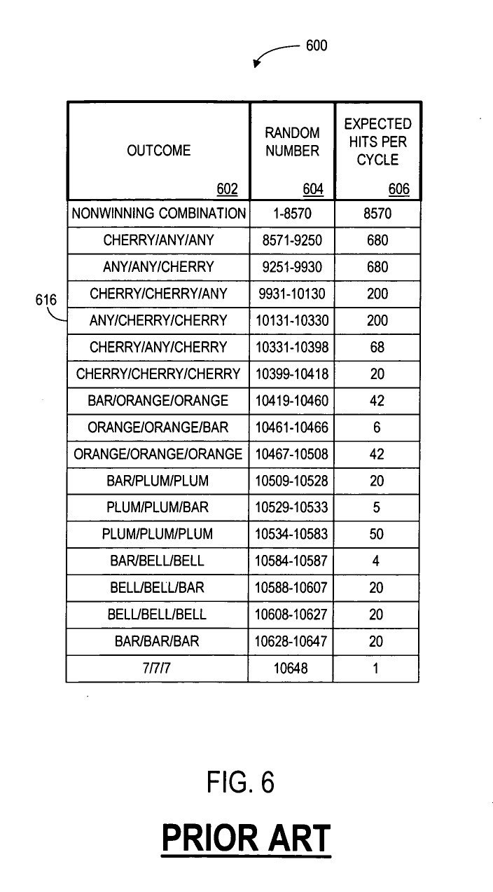

Referring now to FIG. 6, there is depicted a table representing the probability of specific outcomes generated by slot machine 300. Although the present invention does not rely on any specific probability table, the selection of a probability table should be consistent with the requirements and payout amounts of the bonus game of the present invention. Each record of probability table 600 represents an outcome or family of outcomes. Probability table 600 includes an outcome field 602 representing an outcome associated with a record. Probability table 600 further includes random number field 604 and expected hits per cycle field 606. Random number field 604 indicates a range of numbers which, when generated by random number generator 322, result in the associated outcome. For example, random numbers 10131-10330 correspond to outcomes for which the last two symbols are “CHERRY,” as illustrated by record 616. Outcomes of “ANY/CHERRY/CHERRY” are expected to occur 200 times per cycle of 10,648 total plays in the cycle.

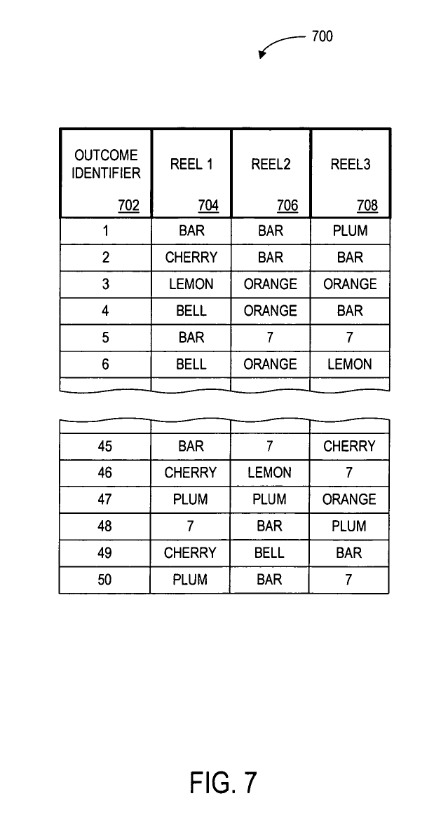

Referring now to FIG. 7, there is depicted outcome table 700 of slot machine 300. Each record of outcome table 300 represents an outcome generated by a play of slot machine 300. Although outcome table 700 may store every outcome from every session, in the illustrated embodiment, outcome table 700 stores the outcomes from every play of a current session. Outcome table 700 includes outcome identifier 702 that functions as a record identifier. Outcome table 700 also includes fields 704, 706 and 708 that represent the symbols from reel 1, reel 2 and reel 3, respectively, which together form the outcome.

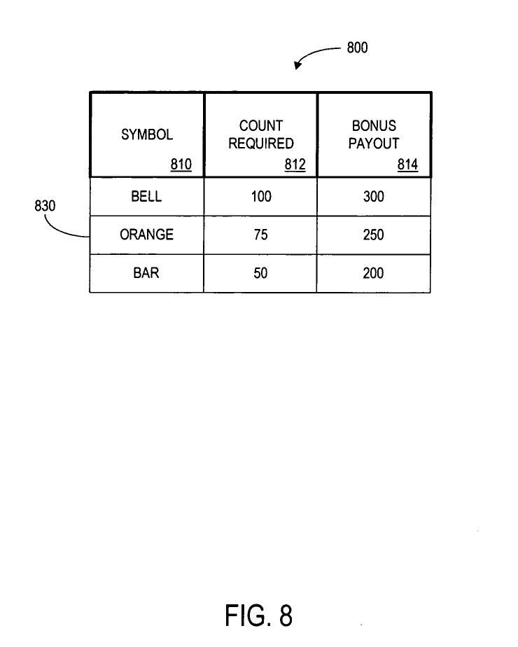

Referring now to FIG. 8, there is depicted tracked symbol reward table 800 of slot machine 300. Each record of table 800 represents a bonus payout and the requirements for achieving the bonus payout. Table 800 includes symbol field 810 and count required field 812. Symbol field 810 and count required field 812 define the requirements for achieving a bonus payout associated with a record. Bonus payout field 814 defines the amount of the bonus payout awarded to a player who achieves the associated requirements.

Description of the Operation

Having thus described the architecture and components of the slot network and slot machines of the preferred embodiment, the operation of the apparatus in accordance with some embodiments will now be described in greater detail with reference to FIGS. 9A and 9B. Taken together, FIGS. 9A and 9B depict a flowchart of an exemplary process 900 employed by slot machine 300 to determine a bonus payout according to the present invention. The process steps are implemented using the instructions of program 306.

The process begins with step 902 in which processor 302 receives a signal to initiate a session. Such a signal could be generated as a result of a player inserting a player tracking card. The session initiation signal could also be generated based on insertion of currency after an extended period during which the slot machine was not used. The session initiation signal represents the beginning of a new session.

The process continues with step 910 which directs processor 302 to receives a signal to initiate game play, such as by a pull of handle 350. At step 912, processor 302 determines an outcome for the game and provides the player a payout associated with the outcome, as shown by step 914. Steps 910-914 are game play steps which may be performed in conjunction with certain operating system and control software (not shown) to conduct the primary game offered by slot machine 300.

Steps 916 through 922 define a logical loop that causes each reel of the slot machine to be examined to determine whether the outcome includes any tracked symbols. At step 916, processor 302 determines which symbol is on the next reel that has not been examined. The first time through the loop, the first reel 326 is considered the next reel that has not been examined. Step 918 directs the flow of processing based on whether the determined symbol is a symbol which is tracked for the purpose of awarding a bonus payout. If the determined symbol is a tracked symbol, processor 302 is directed to update the running count of the tracked symbol. Otherwise, processor 302 determines whether all of the reels have been examined, and causes the process flow to loop back to step 916, accordingly.

Referring now to FIG. 9B, steps 924 through 936 define a logical loop that causes processor 302 to examine the running count of each tracked symbol to determine whether a reward level has been achieved. At step 924, the running count 412 of a tracked symbol is retrieved from tracked symbol table 400 and compared to the corresponding count required 812 of tracked symbol reward table. As illustrated by step 926, if a reward level has not been achieved, processor 302 is directed to proceed to step 936.

If a reward level has been achieved, processor 302 determines the reward at step 928 and provides the reward to the player at step 930. The reward is determined by retrieving the corresponding bonus payout 814 from tracked symbol reward table 800. The reward may be provided to the player in a number of ways, including dispensing coins, updating a credit meter, or crediting an account of the player based on identifying information stored on a player tracking card.

At step 932, processor 302 adjusts the running count of the tracked symbol to reflect the reward. In its simplest form, step 932 includes subtracting the count required to achieve the reward from the corresponding running count. Alternately, step 932 could include setting the running count to zero, or in an embodiment in which each occurrence is individually tracked, step 932 would include updating the table of occurrences 450. At step 934, processor 302 is directed to adjust the running count of the tracked symbol to reflect expired occurrences. At step 936, processor 302 is directed to continue examining tracked symbols until all tracked symbols have been examined.

At step 938, processor 302 determines whether the session has been terminated. If the session has not been terminated, process flow is directed back to step 910. Otherwise, the process concludes. The determination of whether a session has been terminated may be made in any number of ways, including detecting the removal of a player tracking card from player tracking device 338. Alternatively, slot machine 300 may determine that a session has been terminated after an extended period of inactivity.

Expiration of Tracked Symbols

Many variations of the present invention are possible. According to the present invention, each occurrence of a tracked symbol has an associated expiration criterion. As described, each accumulated tracked symbols expire after a predetermined time. Of course, the present invention supports accumulated tracked symbols that expire after a pre-determined number of plays. For example, after 100 plays, a bell symbol expires. In either event, players are able to accumulate a lot of tracked symbols early in a session providing the appearance that a large jackpot is readily attainable. Late in a session, the occurrences expire at a rate nearly equal to the rate of tracked symbol acquisition, giving the impression that the player is close to winning. This increases the anticipation and excitement of the game because the player feels like he is constantly on the verge of a bonus payout. In either embodiment, the time remaining or plays remaining could be recorded in association with each accumulated occurrence of a tracked symbol. An advantage of a time-based embodiment is that it encourages players to play quickly. Although fast players will tend to win more bonuses, they will also tend to spend more money playing the slot machine.

Storage of Running Counts

Although in accordance with some embodiments, as described, running counts are stored locally at the slot machine, the running counts could be associated with a player identifier from a player tracking card and stored by server 200 to allow a player to “carry” the running counts from slot machine to slot machine. Occurrences of tracked symbols stored with the server might expire after a number of hours or days. Such an embodiment also enables a player to end a playing session, save the running counts, and return to the same machine at a later time to resume the game using the stored running counts.

Alternatively, the running counts of accumulated tracked symbols could be stored on the player's tracking card. Such an embodiment would also allow a player to carry running counts from slot machine to slot machine. Any existing running counts would be stored on a player's tracking card at the end of a playing session. The running counts would be read off the card by the next slot machine into which the tracking card is inserted. That machine's running counts would be adjusted accordingly. This embodiment requires that the player card have data storage capability, such as that found in a smart card or writable magnetic strip.

Alternate Rewards

In addition to variations in the expiration of accumulated tracked symbols, variations in determining a bonus payout are also possible. Specifically, the determination of a bonus payout could be based on how many spins or how much time it took to achieve the reward level. For example, the bonus payout for accumulating 100 oranges may be 350 coins if they are accumulated within 30 spins, 325 coins if they are accumulated within 40 spins, and 300 coins if they are accumulated within 50 spins.

Alternatively, the reward provided to a player for attaining a particular reward level might be a payout multiplier instead of coins. For example, upon reaching 50 oranges, the player might earn a ten times multiplier for “ORANGE/ORANGE/ORANGE” enabled for the next 100 handle pulls. In yet another embodiment, slot club reward points could be awarded in place of currency.

Rewards could also be provided for expiring occurrences of tracked symbols. For example, every time a tracked symbol expires (i.e. is deducted from the running count), the player would be awarded a slot club reward point, a percentage of a slot club reward point or a cash-back reward (e.g. $ 0.01). The reward point or cash-back could then be used in the casino restaurants and/or shops. This extra reward would make the gaming experience more enjoyable by rewarding the player for events that would otherwise be considered “non-winning” events during slot play. The reward point or cash-back earned by the player would be tracked through the player's tracking card in a conventional manner.

Group/Team Play

Although the described embodiment is directed toward individual play, it should be understood that an alternate embodiment of the present invention could support group play. Players could form teams, pooling their accumulated tracked symbols into running counts corresponding to the team. Once the once a reward level is achieved by the team, each team member would be provided a share of the associated bonus. A team may be formed interactively by allowing the player to actuate a “Team Play” button on the gaming device (not shown). Server 200 would link the player to at least one other player in response to the signal resulting from the actuated “Team Play” button.

Alternatively, players may form teams by registering at a kiosk or casino slot club center. In such an embodiment, the player identifiers of the team members would be stored in association with one another and a team identifier in a registration table. The registration table would be accessed when a team member inserts his tracking card into the card reader of a slot machine. The slot would read the player identifier from the player tracking card and transmit it to the server. The server would determine whether the player is registered on a team and, if so, would retrieve the team record in order to update any symbols accumulated by the player into the running counts of the team.

Rules Variations

A slot machine, in accordance with some embodiments, could also include program steps for alternate rules. Specifically, each tracked reel symbols could be associated with a particular reel. For example, on a three reel machine, only bars occurring on the first reel would be accumulated, only bells appearing on the second reel would be accumulated and only oranges appearing on the third reel would be accumulated. A tracked symbol meter could be disposed above each reel for visual association.

Other variations of the disclosed embodiment are also envisioned. Specifically, one embodiment could require that a tracked symbol only counts towards the running count if it is not part of a winning combination. Since the present invention is directed toward rewarding players in some way even when their outcome is not a winning one, it is not strictly necessary to reward players a second time for a winning outcome to achieve the objects, features and advantages of the present invention. For example, if bars, bells, and oranges are tracked symbols, and the player receives an outcome of CHERRY-CHERRY-ORANGE, he receives a payout of five coins for every coin wagered in accordance with a conventional payout schedule. Employing the alternate embodiment of the present invention, the player would receive the payout of five coins (if he only wagered one coin) and the orange that is part of that outcome would not be added to the running count of oranges.

Other variations in the rules are also possible. For example, the rules could be altered to adjust the running count only if the player has wagered the maximum amount allowable. Another variation of the rules may enable a player to receive credit for an occurrence of a tracked symbol, even if it is not part of an outcome. Specifically, symbols that are not on the payline but appear on the screen of the slot machine count towards the running count. For example, if an orange is just above or below the payline and oranges are tracked symbols, the running count for oranges would be adjusted.

Another variation of the rules includes cancellation of symbols. In this embodiment, one type of reel symbol may cancel another. In other words, one type of reel symbol may decrease the running count of another reel symbol. For example, a cherry may cancel an orange. Accordingly, if an orange is a tracked symbol, and the running count of oranges is twenty. A player receiving an outcome of CHERRY-7-7 would find his orange balance decreased by one to nineteen.

Yet another variation of the rules includes providing a bonus payout for achieving a certain combination of tracked symbols. For example, a bonus payout of fifty coins could be awarded if each of the running counts is equal to ten simultaneously. In another example, a bonus payout of fifty coins could be awarded if a specific running count exactly matched a required count. The particular number that the running counts would have to equal could be determined by the casino or selected by the player using the keypad 342.

Still another variation of the rules includes displaying special offers to the player upon achieving a predetermined reward level. Such offers could include a free night's stay at the casino hotel, a ticket to a show or other casino event or a free dinner at the casino restaurant. The offers could be determined by the server and be based on revenue-management rules in order to optimize the revenue of the casino. For example, a show starting in a couple of hours may have a large number of empty seats which the casino would rather give away than have them remain empty. The server may determine these offers by checking databases of reservations for the casino hotel or show. The offers may be made upon achieving the predetermined reward level (e.g. “Collect 50 Plums to Win a Free Room!”) in place of the monetary award. Alternately, the reward offers could be made when the player is close to achieving the sought after balance (e.g. has 48 plums accumulated). Depending on the reward, it may be more cost effective for the casino to make the offer rather than pay a monetary reward to the player if he does get to the sought after level. If the player accepts the offer, his balance would be reset to zero.

Video Poker Embodiment

The embodiments described herein may be applied to video poker, as well as to slot machines. As in the slot machine embodiments, in a video poker embodiment, a player achieves a running count to earn a reward. The running count is preferably a count of occurrences of types of cards. A type of card may be a specific card value (e.g., aces, twos and threes), a set of card values (e.g., face cards) or a particular suit (e.g., hearts, diamonds, spades and clubs).

In the case where the tracked card types are suits, an exemplary video poker tracked symbol reward table is illustrated as Table I below. Of course, the expiring nature of the card types would apply in the same ways as described with respect to the slot machine embodiments.

TABLE I
Video Poker Tracked Symbol Reward Table

| Suit | Count Required | Bonus Payout |
|---|---|---|
| Hearts | 100 | 200 |
| Clubs | 150 | 250 |

In an alternate embodiment, a running count may be adjusted based on the numeric card values (e.g., face cards are valued at ten, aces are valued at eleven). Regardless of what a running count represents, there are many variations regarding how to adjust the running count in a video poker embodiment. Specifically, there are several ways to determine whether an occurrence of a card type has been generated.

For example, all cards displayed during a game (including discarded cards) could be examined to determine whether a card type occurrence has been generated. In other words, every card displayed during a game is considered in the decision to adjust the running count. In an alternate embodiment, the cards examined to determine whether a card type occurrence has been generated may be limited to only the cards of the final outcome. In such an embodiment, only the cards comprising the final hand are considered in the decision to adjust the running count. In yet another embodiment, only certain card positions may be examined to determine whether an occurrence of a card type has been generated. For example, only the cards displayed in the first card position might be considered in the decision to adjust the running count. Of course, other ways to determine occurrences of tracked symbols in a video poker embodiment are also possible, such as by examining only discarded cards.

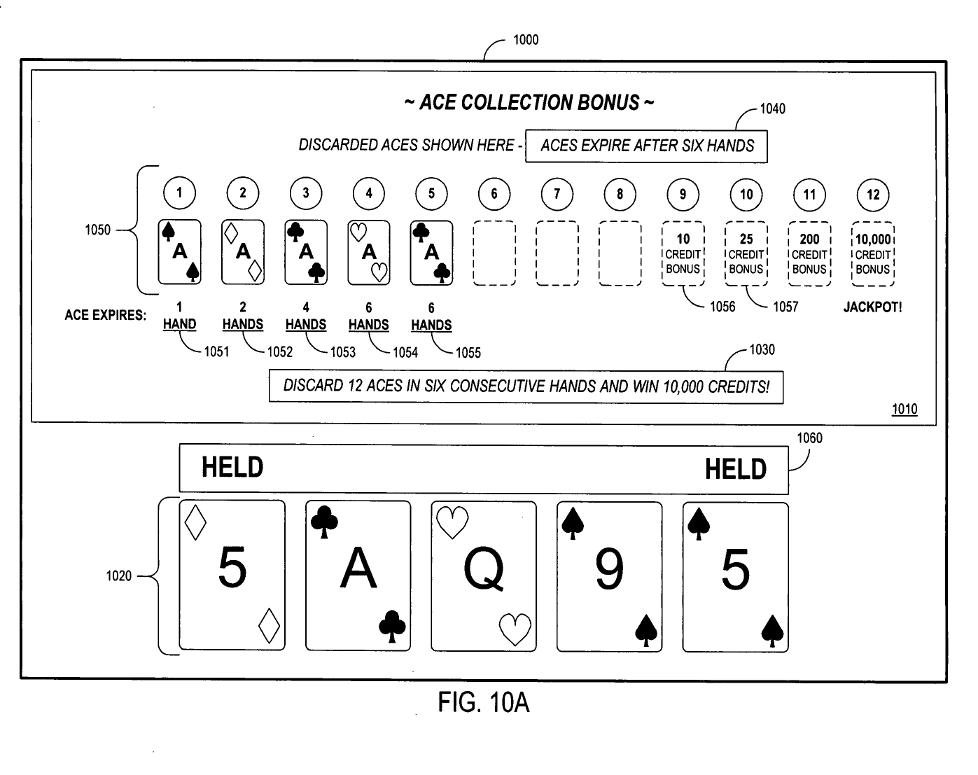

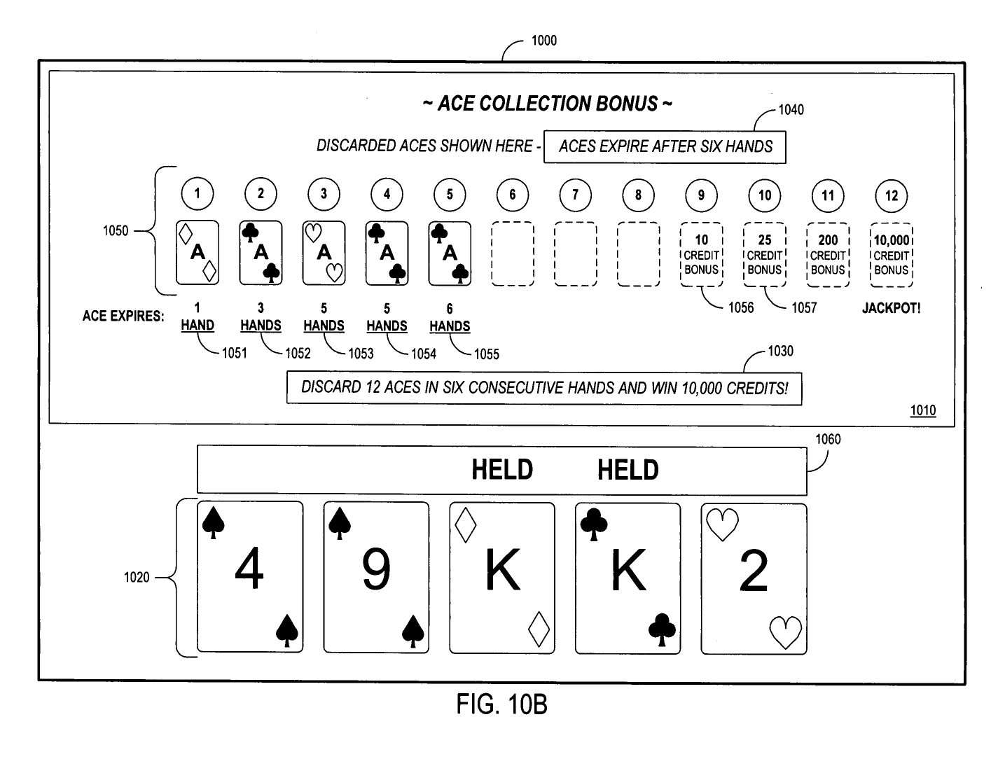

Referring now to FIG. 10A, illustrated therein is an example of information that may be output to a player of a video poker device, in accordance with one embodiment in which a player may accumulate game indicia such as a type of card. The information depicted in FIG. 10A is information that may be output in a video poker embodiment in which a player may earn a bonus by collecting discarded cards of a particular type within a specified number of consecutive games. Although the condition for qualifying for a bonus that is illustrated specifies accumulating a twelve (12) aces within six consecutive hands, it should be understood that, as described above, many other (e.g., different or additional) condition(s) may be utilized and many modifications to the illustrated embodiment are within the spirit and scope of the invention. For example, the type of card to be collected may be modified (or, e.g., different types of cards may need to be collected). In another example, the number of cards to be collected may be modified. In another example, the method of collecting the cards may be modified (e.g., cards occurring in a final hand may be collected in lieu of discarded cards). In yet another example, the number of games within which the specified cards are to be collected may be modified. In yet another embodiment, the specified cards may be required to be collected within a specified duration of time rather than within a specified number of games. Other modifications would be apparent to one of ordinary skill in the art upon reading the present disclosure.

FIG. 10A comprises an exemplary display 1000 that may be a display of a video poker device. The display 1000 comprises two display areas: display area 1010 and display area 1020. Display area 1010 displays information relevant to determining whether the player has qualified for a bonus. In the depicted embodiment, display area 1010 displays information relevant to the accumulation by a player of a specific type of card (aces) over a specified number of game (six consecutive games). Display area 1020 displays information relevant to the primary video poker game, namely the cards comprising a player's initial poker hand and an indication of which cards the player has indicated should be held and which cards the player has indicated should be discarded.

In one or more embodiments, display area 1010 may be a display area of a first display device associated with a video poker device, while display area 1020 may be a display area of a second display device associated with a video poker device. Further, in one or more embodiments some or all of the information depicted in display area 1010 and some or all of the information depicted in display area 1020 may be displayed on a single display area and/or integrated, merged and/or combined in some manner.

Display area 1010 includes, in section 1030, an indication of a bonus that the player may earn and an indication of how the player may qualify for the bonus. As described, in the particular embodiment depicted in FIG. 10A, a player may qualify for a bonus of 10,000 credits if the player discards twelve (12) aces in six (6) consecutive game plays. As described herein, an occurrence of a tracked symbol in a video poker embodiment may be determined by examining only discarded cards. FIG. 10A illustrates one embodiment utilizing this method of determining occurrences of a tracked symbol.

Display area 1010 further includes, in section 1040, an indication of an expiration condition that defines a condition upon the satisfaction of which a card accumulated by a player expires (e.g., the running count of aces is decremented based on the satisfaction of the expiration condition). Specifically, section 1040 of display area 1010 specifies that an ace expires after six hands. Thus, if six hands have been played since the addition of a particular ace to the running count of aces and a bonus has not been qualified for, the ace is removed from the running count.

Display area 1010 further includes, in section 1050, a representation of each ace that has been discarded by a player and that is included in the running count of aces (i.e., each ace that has not yet expired). As can be seen, section 1050 includes placeholders for twelve aces via twelve card positions. The card positions are populated as an ace is discarded from a hand. The card positions are unpopulated (as will be illustrated in FIG. 10B) as an ace expires before a bonus has been qualified for.

Display area 1010 further includes, in sections 1051 through 1055, an indication of how many hands are left before each respective ace accumulated by the player will expire. For example, section 1051 of display area 1010 indicates that the ace of clubs in the first position will expire in one (1) additional hand. Thus, based on the expiration condition of the embodiment of FIG. 10A, it can be deduced that the ace of spades in the first position was discarded from a hand five (5) hands ago. Similarly, section 1052 indicates that the ace of diamonds in the second position will expire in two (2) hands, thus indicating that the ace of diamonds was discarded from a hand four (4) hands ago.

It should be noted that an expiration condition may define any number of hands after which a card may expire, or another type of occurrence that causes an expiration of an accumulated game indicium. For example, in one embodiment an expiration condition may define that an accumulated game indicium expires after the passage of a predetermined period of time from a time at which the game indicium was first added to the running count. In another example, an expiration condition may define an occurrence of a predetermined event (e.g., a final hand corresponding to an outcome of at least a predetermined amount, a particular card being included in an initial or final hand, etc.) that causes an expiration of one or more accumulated game indicia.

It should further be noted that FIG. 10A depicts the status of information after the ace(s), if any, in the hand depicted in display area 1020 have been added to the running count of aces in section 1050 of display area 1010. In other words, the ace of clubs that is the second card of the hand depicted in display area 1020 has been added to the running count of aces and is depicted in the fifth position of the cards in display area 1010 and is thus the fifth ace to be discarded by the player in the last six (6) consecutive games.

It should further be noted that although the embodiment of FIG. 10A illustrates game indicia being collected from initial hands of video poker, and in particular cards discarded from initial hands of video poker being collected, in other embodiments cards from final hands of video poker may be collected for a bonus (as described above).

Display area 1010 also indicates that a bonus of a smaller amount may be earned by discarding, and thus accumulating, less than twelve aces. For example, as indicated in the yet-unpopulated ninth card position of section 1050, a bonus of ten (10) credits may be earned if nine (9) aces are discarded in six (6) consecutive hands. As indicated in the yet-unpopulated tenth card position of section 1050, a bonus of twenty-five (25) credits may be earned if ten (10) aces are discarded in six (6) consecutive hands. As indicated in the yet-unpopulated eleventh card position of section 1050, a bonus of 250 credits may be earned if eleven (11) aces are discarded in six (6) consecutive hands.

Referring now to FIG. 10B, illustrated therein is display 1000 upon the obtainment of one additional consecutive initial hand after the initial hand depicted in FIG. 10A. As can be seen, no additional aces have been obtained and discarded, and thus no additional aces have been added to the running count and/or to section 1050 of display area 1010. As can also be seen, one ace depicted in section 1050 of FIG. 10A is not included in section 1050 of FIG. 10B. This is the ace of clubs that was previously depicted in the first position of section 1050. As illustrated in FIG. 10A, the ace of clubs in the first position was to expire in one (1) additional hand if no bonus was qualified for. Thus, since no bonus was qualified for as a result of the additional hand depicted in section 1020 of FIG. 10B, the ace of clubs in the first position expired and is no longer included in the running count. Further, each of the remaining aces have been moved one position to the left. Thus, although six aces were included in the running count illustrated in section 1050 of FIG. 10A, only five aces are included in the running count illustrated in section 1050 of FIG. 10B.

In one embodiment, a card or game indicia that is “collectable” may be highlighted or indicated to a player as collectable (e.g., during a game play of a primary game or otherwise). For example, in a video poker embodiment, assuming aces are the game indicia being collected, if an initial hand includes an ace, the ace may be highlighted or otherwise indicated to the player as a collectable card. In some embodiments, such a feature may be turned off (e.g., by more experienced players).

In some embodiments, a warning or confirmation message may be output to a player who fails to perform an action or make a selection that would result in the player collecting a collectable game indicia. For example, in a video poker embodiment in which discarded aces are being collected (as illustrated in FIG. 10A and FIG. 10BB), such a message may be output to a player who is dealt an initial hand that includes an ace and who does not discard the ace. Such a message may be, for example, “You have not discarded the Ace of spades. Discarding this ace would help you achieve a bonus. Are you sure you want to proceed?” In some embodiments, such a message may only be output if the collection of the game indicia in question would result in the player qualifying for a bonus. For example, in the above-described embodiment if a player has already collected 9 aces and a 10^{th} ace would result in the player obtaining a bonus, a player who is dealt an ace and does not discard the ace may be provided with a message such as “You have not discarded the Ace of spades. You are just one ace short of a 20 credit bonus. Are you sure you don't want to discard this ace?” In some embodiments, such a feature of outputting confirmation or warning messages to a player may be turned off by a player (e.g., by an experienced player).

In one embodiment, a player may be allowed to pre-pay for the number of consecutive games (or an amount of time) required to earn a particular bonus. For example, in the embodiment of FIG. 10A, a player may be allowed to pre-pay for six consecutive games. In one implementation, a player pre-paying for a number of consecutive games may be provided a discount per game play. For example, if a maximum bet for a particular video poker device is 3 credits per game and a player is pre-paying for six (6) consecutive game plays, the player may be allowed to purchase the six (6) consecutive game plays for fifteen (15) credits rather than the eighteen (18) credits the player would otherwise pay, and still qualify for any payouts corresponding to a maximum bet of three (3) credits per game play while playing the six consecutive game plays. Commonly-owned, co-pending U.S. patent application Ser. No. 10/001,089, filed Nov. 02, 2001 in the name of Walker et al. and entitled GAMING DEVICE FOR A FLAT RATE PLAY SESSION AND A METHOD OF OPERATING SAME, describes in detail various methods of purchasing a plurality of games on a flat rate basis. U.S. patent application Ser. No. 10/001,089 is hereby incorporated by reference for all purposes.

As would be understood by one of ordinary skill in the art, in the embodiments of FIGS. 10A and 10B and other embodiments described herein, fairly substantial bonus payouts may be offered for collections of game indicia while allowing a casino to maintain an acceptable house advantage for the gaming device on which the bonus payouts are offered. This is at least because the bonus payouts may be offset by decreased payouts in the primary game that result from the player foregoing attempts to qualify for payouts in the primary game in lieu of attempting to qualify for a bonus in the secondary collection game. For example, upon being presented with an initial hand that includes a card that may be added to the player's collection and thus help the player qualify for a bonus (e.g., the initial hand includes an ace, in the embodiment of FIGS. 10A and 10B) a player faces a decision as to whether to discard the card from the initial hand and thus have it added to the running count of collected cards or to retain the card for the final hand in the hopes of building a final hand that qualifies for a payout. If the player elects to retain the card, the player is foregoing an attempt to qualify for a substantial bonus. If the player elects to discard the card, however, the player may be foregoing an attempt to build a final hand that qualifies for a payout in the primary game. It should be noted that such decision making adds a level of interest and complexity that may attract player who would not have otherwise played a game if it did not offer the bonus structure described herein.

In one embodiment, collection or accumulation of game indicia may be a primary game rather than a secondary or bonus game. For example, the goal of playing a gaming device may be simply to accumulate specified game indicia in the manner specified by the game rules, with payouts being based on the accumulation of the game indicia in lieu of being based on conventional payout schedules.

As is clear from a reading of the present description, in some embodiments features of the present invention may be implemented without requiring substantial (or, in some circumstances, any) software and/or hardware modifications of a conventional gaming device. For example, as described herein, tracking of game indicia collected or accumulated by a player for purposes of determining whether a bonus payout is due to a player may be performed by a computing device (e.g., server 200), without requiring a gaming device being played by the player associated with the collection of symbols to perform any steps, provide access to any information, and/or transmit any information that the gaming device would not otherwise perform, allow access to and/or transmit.

As is also clear from a reading of the present description, in some embodiments of the present invention, a gaming device may be retrofitted or otherwise modified to allow implementation of one or more features of the present invention. For example, in one or more embodiments, aspects of the present invention, such as determining whether a game indicium qualified to be added to a running count of collected game indicia has been obtained by a player, may be practiced by replacing and/or augmenting one or more components (e.g., hardware and/or software components) of an existing gaming device. Thus, in one or more embodiments, the invention may be applied as a retrofit to existing gaming devices currently available for play within various casinos.

For example, a memory (e.g., computer chip) of the gaming device may be replaced or added, the replacement or additional memory storing a program for instructing the processor of the gaming device to operate in accordance with one or more embodiments of the present invention. In another example, data output via the gaming device (e.g., graphical and/or textual data displayed on the gaming device) may be replaced or added, the replacement or additional data indicating to a player information relevant to one or more aspects of the present invention.

In a more specific example, a gaming device may comprise various electronic components mounted to one or more printed circuit boards (PCBs). Such components may include various hardware described herein, such as a communications port and various controllers of peripheral devices (e.g., a display controller), as well as a memory for storing programming instructions (software) and a processor for carrying out such instructions. One form of memory commonly found in gaming devices is electrically erasable programmable read-only memory (EEPROM). Thus, in one or more embodiments of the present invention, an EEPROM storing data related to one or more collections of game indicia accumulated by a player (e.g., as well as instructions for carrying out other functions performed by the gaming device) may replace an EEPROM previously installed in a gaming device, such that the gaming device may be configured to operate in accordance with various processes of the present invention.

For example, a “game indicia collection module” may be made available for purchase to various casino operators. The module, which may comprise various hardware and software (e.g., an EEPROM storing software instructions), may be installed in an existing gaming device (e.g., a video-reel slot machine, a video poker machine, etc.), such that when the module is installed, players of the device may elect (i) to play a game offered by the gaming device without participating in a bonus game of accumulating game indicia, or (ii) to play a game offered by the gaming device while participating in such a bonus game. Thus, for example, players who are familiar with the games offered by various gaming devices may elect to play them with the added layer of interest offered by a bonus collection game.

While the best mode for carrying out the invention has been described in detail, those familiar with the art to which the invention relates will recognize various alternative designs and embodiments for practicing the invention. These alternative embodiments are within the scope of the present invention. Accordingly, the scope of the present invention embodies the scope of the claims appended hereto.

What is claimed is:

1. A method of facilitating a wagering game, comprising:
determining, for a video poker game, a plurality of initial hands, each initial hand represented by a plurality of cards;
counting occurrences of a discarding of at least one qualifying card from one or more of the plurality of initial hands, thereby determining a count value of the qualifying card; and
determining a bonus payout based on a number of occurrences of the discarding of the at least one qualifying card counted in accordance with an expiration condition,
wherein the expiration condition defines at least one of
(i) a number of game plays, from a game play in which an occurrence occurs, after which the occurrence expires and
(ii) a period of time, from a time at which an occurrence occurs, after which the occurrence expires, and further
wherein the expiration condition is associated with each respective occurrence, such that a first occurrence may expire at a first time and a second occurrence may expire at a second time that is different from the first time.

2. The method of claim 1, wherein counting occurrences of the discarding of the at least one qualifying card includes incrementing the count value by an integer value.

3. The method of claim 1, wherein the expiration condition includes a number of game plays after which an occurrence of the discarding of the at least one qualifying card expires, and
wherein the method further includes determining an expiration of an occurrence of the discarding of the at least one qualifying card based on the expiration condition.

4. The method of claim 1, wherein the qualifying card comprises an ace.

5. The method of claim 1, wherein the expiration condition includes a time after which an occurrence of the discarding of the at least one qualifying card, and
wherein the method further includes determining an expiration of an occurrence of the discarding of the at least one qualifying card based on the expiration condition.

6. The method of claim 1, further including storing the count value on a player tracking card, and wherein the count value includes status data related to an expiration condition of each occurrence of the discarding of the at least one qualifying card.

7. The method of claim 1, further including storing the count value at a slot server, and wherein the count value includes status data related to an expiration condition of each occurrence of the discarding of the at least one qualifying card.

8. The method of claim 1, wherein determining a bonus payout further includes determining the bonus payout based on a number of game plays within which the count value was accumulated.

9. The method of claim 1, wherein determining a bonus payout further includes determining the bonus payout based on a duration of time within which the count value was accumulated.

10. The method of claim 1, further including receiving a wager, and
wherein determining a bonus payout further includes determining the bonus payout based on the wager.

11. The method of claim 1, further including:
determining a payout for a final hand of the video poker game, and
wherein determining a bonus payout comprises determining a multiplier to be applied to the payout.

12. The method of claim 1, wherein determining a bonus payout includes determining points for a slot play reward system.

13. The method of claim 1, wherein determining a plurality of initial hands is performed by a gaming device.

14. The method of claim 1, wherein the gaming device comprises a video poker device.

15. The method of claim 1, further including:
determining whether a card discarded from an initial hand is a qualifying card, wherein the determination is a function of the face value of the card.

16. The method of claim 1, wherein determining a bonus payout comprises:
determining a first bonus payout to be provided to a player if the number of occurrences of the discarding of the at least one qualifying card is a first number, and
determining a second bonus payout to be provided to the player if the number of occurrences of the discarding of the at least one qualifying card is a second number,
wherein the second bonus payout is greater than the first bonus payout and the first number is greater than the second number.

17. The method of claim 1, further comprising:
causing information about at least one of the following to be displayed via a display device of a gaming device
(i) the count value;
(ii) the expiration condition; and
(iii) the bonus payout.

18. The method of claim 17, wherein causing information about the expiration condition comprises causing an indication of an imminence of an expiration of at least one of the cards to be output.

19. A gaming device, comprising:
a processor operable to facilitate a wagering game;
a display device operable to display information about the wagering game;
a memory operable to store a program,
the program operable with the processor to:
perform the method of claim 1.

20. A computer-readable medium, the computer-readable medium storing instructions that, when read by a device cause a processor of the device to perform the method of claim 1.
